(19) United States
(12) Patent Application Publication
(10) Pub. No.: US 2023/0123748 A1
(43) Pub. Date: Apr. 20, 2023

(54) SLAB HANDLING SYSTEM

(71) Applicant: GMR Quality Stone Products, Sterling Heights, MI (US)

(72) Inventor: Craig Griffin, Sterling Heights, MI (US)

(21) Appl. No.: 17/965,930

(22) Filed: Oct. 14, 2022

Related U.S. Application Data
(60) Provisional application No. 63/255,904, filed on Oct. 14, 2021.
(60) Provisional application No. 63/307,160, filed on Feb. 6, 2022.

(51) Int. Cl. B66C 1/02; B25J 15/06

(52) U.S. Cl. CPC B66C 1/0243; B25J 15/0616

(57) ABSTRACT

A slab handling system provides an accessory that can be configured to secure vacuum grippers to a beam. The accessory includes a body having a passageway therethrough for receiving the beam. The body further including slots on either side of the passageway that are configured to receive connectors of a vacuum gripper. In one embodiment the accessory can also be configured as a height-adjusting device. In one embodiment the accessory can also be configured as a traction device. The height-adjusting device and the traction device may be used in conjunction with the accessory and vacuum grippers to facilitate handling of one or more slabs.

### BACKGROUND

Slabs of granite, marble or the like can be extremely heavy and large. They can be very difficult to carry and move into place, such as onto kitchen cabinets. At the same time, these slabs are breakable and can be quite expensive.

### SUMMARY

In some embodiments disclosed herein, a slab handling system includes a plurality of vacuum grippers and a beam securing the plurality of vacuum grippers to one another. The beam may be straight or the beam may be L-shaped.

In some embodiments, an accessory is provided for the slab handling system. The accessory includes a body having a passageway therethrough for receiving a beam. The body may further include slots on either side of the passageway, configured to receive connectors of a vacuum gripper. A lateral aperture may extend through the body on each side of the passageway in a direction parallel to the passageway. The lateral apertures may intercept the slots. A vertical aperture may extend through the body on each side of the passageway through an upper surface and lower surface of the body in a direction perpendicular to the passageway.

The accessory may include a pin movable toward and away from the passageway for securing the body to a beam received in the passageway. The pin may be movably mounted to an upper surface of the body and may be spring-biased downward to an engaged position. A handle at an upper end of the pin may be rotatable to lock the pin in an upward, disengaged position and to release the pin to be spring-biased downward to the engaged position.

The accessory may be configured to include a connecting plate received in each slot and retained in the slots by threaded fasteners received in the lateral apertures.

The accessory may be configured with a threaded rod threadably received in each vertical aperture and extending completely through the body. A handle may be formed on an upper end of each threaded rod and a foot may be formed on a lower end of each threaded rod.

The accessory may be configured with threaded rod threadably received in each lateral aperture and extending completely through the body. A handle may be formed on one end of each threaded rod and a foot may be formed on an opposite end of each threaded rod.

More generally, the slab-handling system may include a beam received in the passageway of the accessory. The beam may include an aperture into which the pin is received, thereby securing the beam in the passageway. The slab-handling system may include a vacuum gripper having connectors received in the slots of the body and secured in the slots of the body.

Optionally, the system also includes a second accessory secured to a second vacuum gripper, wherein the beam is received in the passageway of the second accessory.

In use according to a technique disclosed herein, the first vacuum gripper and the second vacuum gripper may be secured to a slab via a vacuum force. According to another technique, the first vacuum gripper is secured to a first slab via vacuum force and the second vacuum gripper is secured to a second slab via vacuum force. The first slab and the second slab may be generally parallel to one another. In another technique, the first slab and the second slab are generally perpendicular to one another.

In some aspects, the techniques described herein relate to a slab-handling system including a first accessory having a passageway and a second accessory having a passageway, wherein a beam is received in the passageways of the first accessory and the second accessory. The body of the first accessory and the body of the second accessory may be identical.

### BRIEF DESCRIPTION OF THE DRAWINGS

FIG. 1 is a perspective view of a slab handling system according to a first embodiment in a lifting configuration connected to a slab.

FIG. 2 is a top view of a commercially available vacuum gripper used in the slab handling system of FIG. 1.

FIG. 3 is a side view of the vacuum gripper of FIG. 2.

FIG. 4 is an upper perspective view of a securing assembly used in the slab handling system of FIG. 1.

FIG. 5 is a bottom perspective view of the securing assembly of FIG. 4.

FIG. 6 is a outer upper perspective view of the securing assembly of FIG. 4.

FIG. 7 is a outer view of the securing assembly of FIG. 4.

FIG. 8 shows the slab handling system of FIG. 1 in a seam setter configuration secured to two adjacent slabs.

FIG. 9 is an inner upper perspective view of a traction device used in the configuration of FIG. 8.

FIG. 10 is an outer bottom perspective view of the traction device of FIG. 9.

FIG. 11 is a top view of the traction device of FIG. 9.

FIG. 12 is a bottom view of the traction device of FIG. 9.

FIG. 13 is a perspective view of the slab handling system of FIG. 1 in a miter configuration, secured to two perpendicular, adjacent slabs.

FIG. 14 is a perspective view of a universal adjusting device for use in the slab handling systems disclosed herein.

FIG. 15 is a bottom view of the universal adjusting device of FIG. 14.

FIG. 16 is a perspective view of the universal adjusting device of FIG. 14 configured as a traction device.

FIG. 17 is an inner perspective view of the traction device of FIG. 16.

FIG. 18 is a first side perspective view of the universal adjusting device of FIG. 14 configured as a height adjusting device.

FIG. 19 is a second side perspective view of the height adjusting device of FIG. 18.

FIG. 20 is a top view of the universal adjusting device of FIG. 14 configured as securing device and secured to a vacuum gripper.

FIG. 21 shows a slab handling system including a plurality of the universal adjusting devices and vacuum grippers of FIG. 20 secured to a slab.

FIG. 22 is a top view of the slab handling system of FIG. 21 in a seam setter configuration secured to two adjacent, coplanar slabs.

FIG. 23 is a front view of the slab handling system of FIG. 21 in a miter configuration, secured to two perpendicular, adjacent slabs.

FIG. 24 is a perspective view of the configuration of FIG. 23.

FIG. 25 is a perspective view of an optional beam connector.

FIG. 26 is another perspective view of the beam connector of FIG. 25.

FIG. 27 is an enlarged view of a portion of the beam connector of FIG. 25 showing one of the spherical closures.

FIG. 28 shows the optional L connector of FIG. 23.

FIG. 29 is an inner perspective view of the L connector of FIG. 28.

FIG. 30 is another perspective view of the L connector of FIG. 28.

FIG. 31 shows an optional handle attachment.

### DETAILED DESCRIPTION

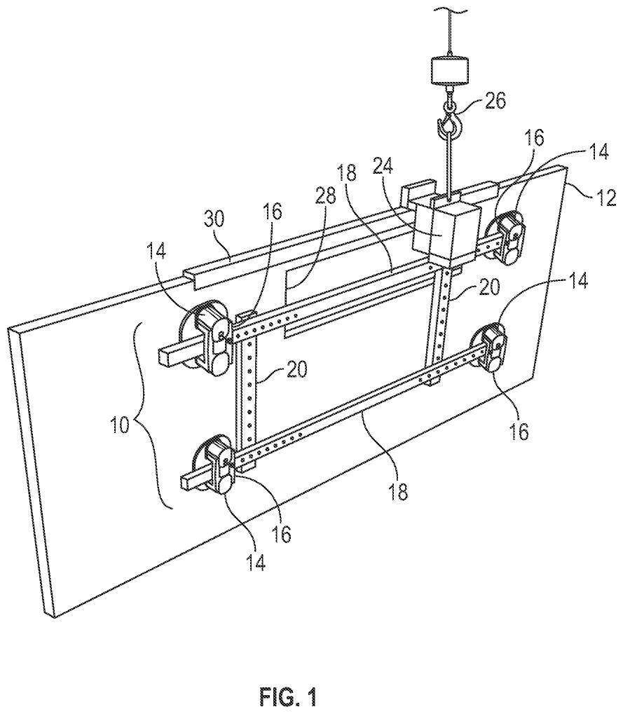

A novel slab handling system 10 is shown in FIG. 1 in a lifting configuration where it is used to lift, carry and move a large, heavy slab 12, such as granite, marble, etc. The system 10 includes a plurality of vacuum grippers 14. Suitable vacuum grippers 14 are commercially available from several manufacturers, including the Grabo brand vacuum grippers 14. A novel securing accessory 16 is secured to each vacuum gripper 14.

A pair of beams 18 are each secured to two of the securing accessories 16 (and thereby to two of the vacuum grippers 14). The beams 18 may be metal such as steel with a rectangular hollow cross-section. Similar beams 20 are arranged transversely to the beams 18 and are pinned against the slab 12 by the pair of beams 18. The system 10 reinforces the slab 12 while it is being lifted and moved, including while it is being tilted onto a cabinet or other object.

In FIG. 1, the slab 12 has a large opening 28 therethrough for a sink, as is common. The large opening 28 creates a narrow strip of the slab. A metal frame 30 having a U-shaped cross-section reinforces the narrow strip of the slab 12 adjacent the opening 28, as is known. As is also known, a clamp 24 may be used to grasp and lift the slab 12 and may be connected to a hook 26, such as at the end of a crane. The system 10 is also useful for hand-carried slabs 12 as well (i.e. without the clamp 24 and hook 26).

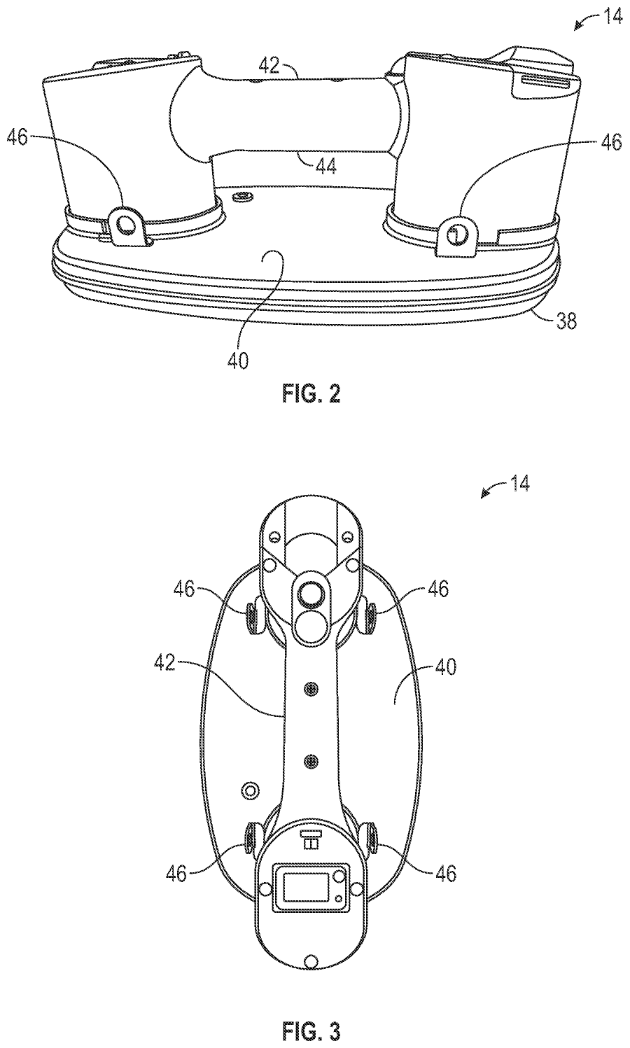

FIGS. 2 and 3 illustrate the vacuum gripper 14 shown in FIG. 1. Again, other types of vacuum grippers 14 can be used. This vacuum gripper 14 has a seal 38 extending around a lower surface of a body 40. As is known the vacuum gripper 14 can generate a strong vacuum below the body 40 that is sufficient to lift several hundred pounds if the seal 38 can seal against a smooth surface, such as the slab 12. The vacuum gripper 14 also includes a handle 42 defining a passageway 44 between the handle 42 and the body 40. Connectors 46 are formed on the body 40. In this case two connectors 46 project upward from the body 40 on each side of the handle 42. In the example vacuum gripper 14, the connectors 46 are metal eyelets.

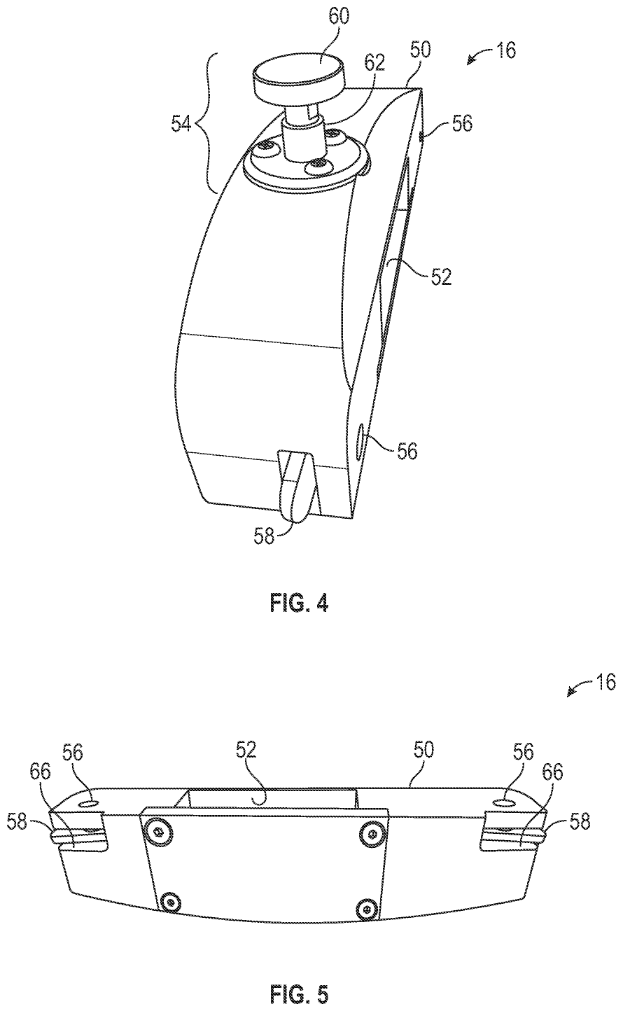

FIGS. 4-7 are more detailed drawings of the securing accessory 16. Referring to FIG. 4, the securing accessory 16 includes an elongated body 50 having a passageway 52 therethrough (perpendicular to the long axis of the elongated body 50). A spring-pin assembly 54 is mounted to an upper surface of the body 50 above the passageway 52. The spring-pin assembly 54 includes a handle 60 secured to a collar 62. The collar 62 is secured to the upper surface of the body 50. The handle 60 is slidable relative to the collar 62 in a direction perpendicular to the upper surface of the body 50 and is spring-biased toward the body 50. Apertures 56 are formed completely through the body 50 on either side of the passageway 52 in a direction parallel to the passageway 52 and perpendicular to the long axis of the elongated body 50.

FIG. 5 is a bottom perspective view of the securing accessory 16. Slots 66 are formed in bottom, outer corners of the body 50 and intersect the apertures 56. Connecting plates 58 are received and retained in the slots 66 and have corresponding apertures aligned with the apertures 56.

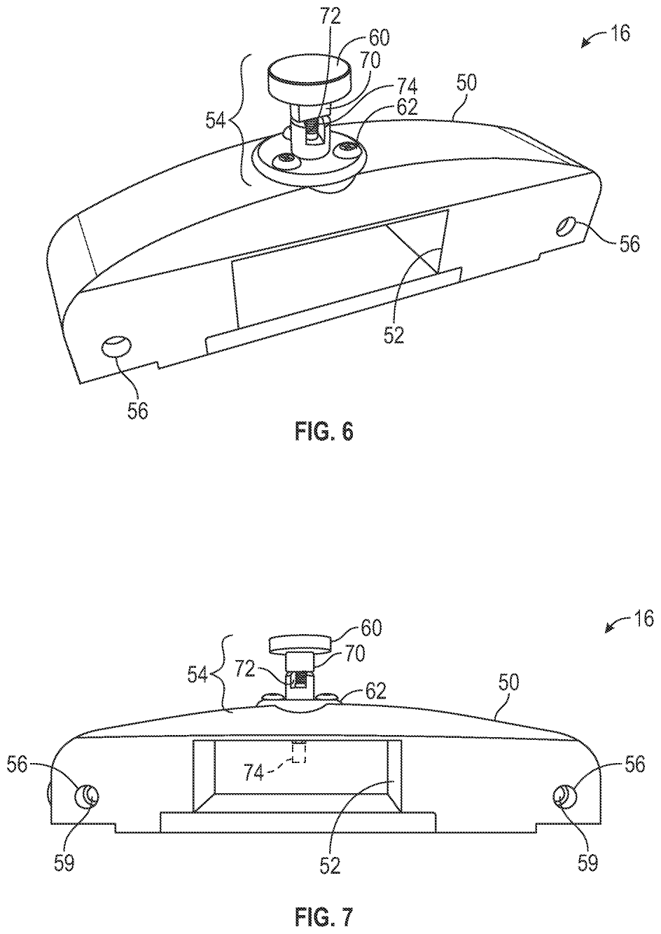

Referring to FIG. 6, the handle 60 of the spring-pin assembly 54 includes a tenon 70 projecting downward therefrom. The collar 62 includes a corresponding mortise 72 that can receive the tenon 70 when the handle 60 is rotated to align the tenon 70 with the mortise 72. A pin 74 projects downward from the tenon 70 and handle 60 into the body 50. The tenon 70 is spring-biased into the mortise 72. When aligned, the pin 74 projects downward through an upper portion of the body 50 into the passageway 52. This is shown in broken lines in FIG. 7. Fasteners 59, such as screws, are received in the apertures 56 and secure the connecting plates 58 in the slots 66. The fasteners 59 may be threadably secured to the connecting plates 58.

Returning to FIG. 1, the securing accessory 16 are each connected to one of the vacuum grippers 14. Two of the eyelets 46 (FIG. 2) are received in the slots 66 (FIG. 5) adjacent the connecting plates 58. The threaded fasteners 59 extending through the apertures 56 in the body 50 and through the connecting plates 58 are then tightened so that they extend through the eyelets 46, thereby securing the securing accessory 16 to the vacuum gripper 14.

The beams 18 are received in the passageways 52 through the securing accessory 16 and secured thereto by rotating the handles 60 of the spring-pin assembly 54 to permit the pins 74 to drop into apertures in the beams 18. The cross-beams 20 are placed below the beams 18. The vacuum grippers 14 are then secured to the slab 12 via their vacuum force, creating the reinforcing handling system 10 of FIG. 1. Again, the system 10 can be used to hand-carry the slab 12 and/or lift it with machinery, such as the clamp 24 and hook 26.

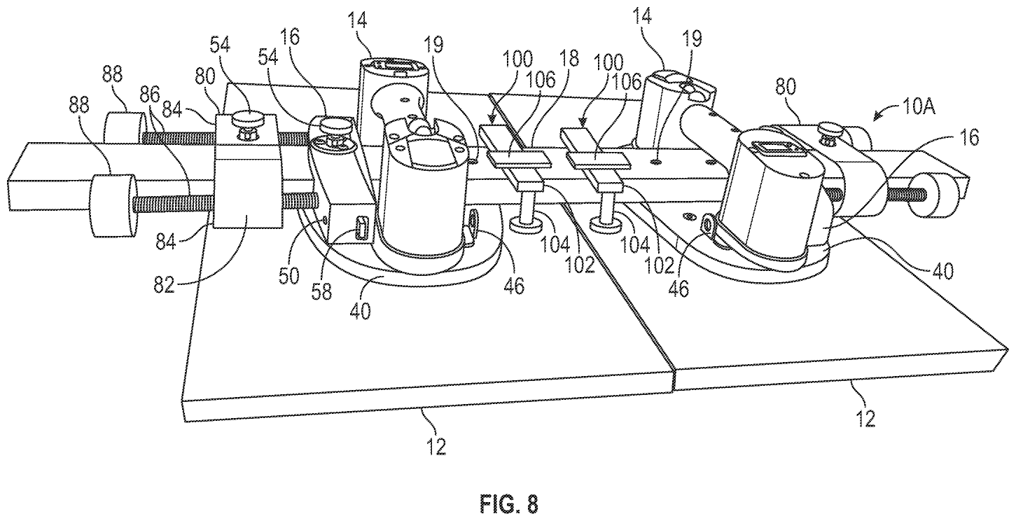

FIG. 8 shows a seam setter configuration 10A of the above system 10, with the addition of two novel traction devices 80. In this configuration, two securing assemblies 16 are each secured to a vacuum gripper 14, as above. Each vacuum gripper 14 is secured to one of two adjacent slabs 12.

In this configuration, at least while moving the slabs 12 toward one another, the spring-pin assemblies 54 of the securing assemblies 16 are not secured to the beam 18. Instead, each traction device 80 is secured to the beam 18 outward of the securing accessory 16, such that the two securing assemblies 16 are between the traction devices 80. Each traction device 80 includes a body 82, threaded apertures 84 extending parallel to one another through the body 82 and threaded rods 86 threaded into the threaded apertures 84. Each threaded rod 86 bears on the body 50 of the adjacent securing accessory 16. Handles 88 are provided at outer ends of the threaded rods 86.

A spring-pin assembly 54 (similar to that described above with respect to the securing accessory 16) is secured to the body 82 of the traction device 80. The spring-pin assembly 54 secures each traction device 80 to the beam 18. Again, in this configuration, the securing assemblies 16 are secured to the vacuum grippers 14 but not to the beam 18. The traction devices 80 are secured to the beam 18 and each has the pair of threaded rods 86 that bear on the body 50 of the adjacent securing accessory 16.

In use, the handles 88 of the threaded rods 86 are turned to push the body 50 of the securing accessory 16 away from the body 82 of the traction device 80. This has the effect of pulling the two slabs 12 toward one another. In the example shown, two traction devices 80 are shown, but it is possible to use just one by securing the other securing accessory 16 (the one not immediately adjacent the one traction device 80) to the beam 18.

Additionally, height-adjusting devices 100 may be secured to the beam 18 between the vacuum grippers 14, one over each slab 12. The height-adjusting devices 100 each include a body 102 secured to the beam 18 (or slidable relative to the beam 18), a threaded rod 104 extending through the body 102 in a direction perpendicular to the slab 12, and a handle 106 at an outer end of the threaded rod 104.

By turning the handles 106 of the two height-adjusting devices 100, the relative heights of the adjacent slabs 12 can be precisely controlled to make them flush and even. The configuration 10A can be used to precisely and properly place the slabs 12 relative to one another and then to leave the slabs 12 in place until the slabs 12 are permanently set.

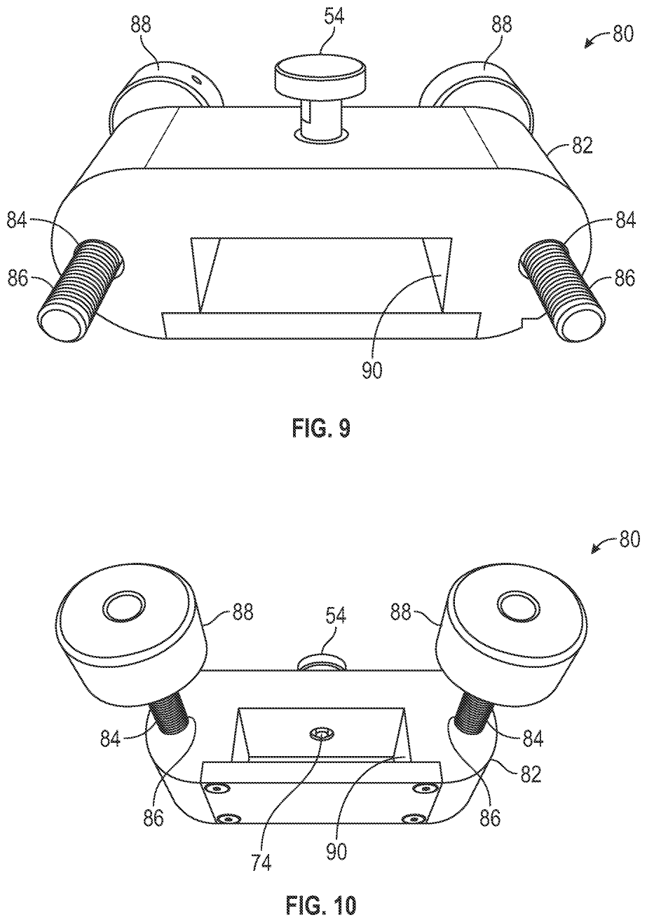

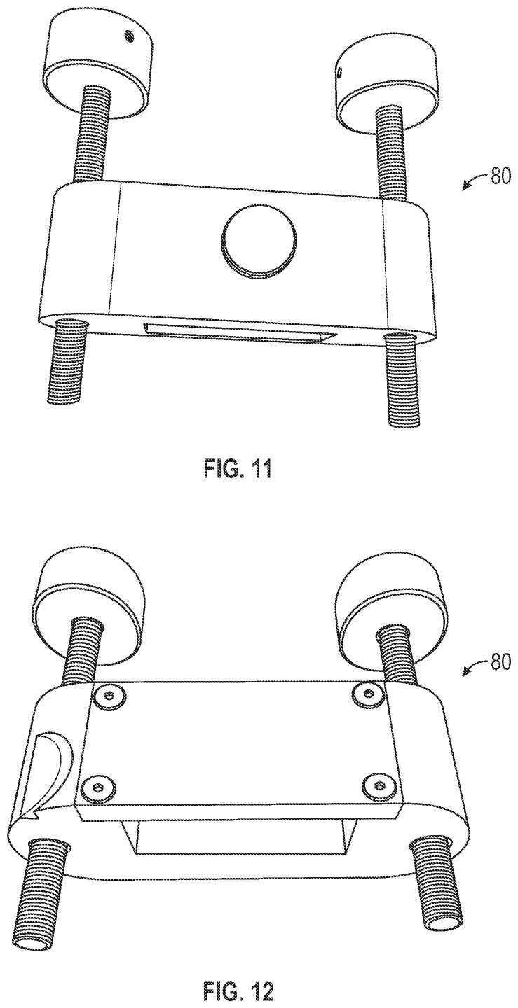

FIGS. 9-12 are more detailed drawings of the traction device 80. Referring to FIG. 9, the traction device 80 includes a body 82 having a pair of parallel apertures 84 therethrough. The apertures 84 are parallel to the passageway 90 through the body 82. Threaded rods 86 are threaded through the apertures 84. Handles 88 are formed at outer ends of the threaded rods 86. A passageway 90 extends through the body 82 parallel to the apertures 84.

A spring-pin assembly 54 (similar to that described above) is secured to the body 82 in a manner similar to the securing accessory 16. In particular, FIG. 10 shows the pin 74 that can project into the passageway 90 to be received in apertures in the beam 18 to secure the traction device 80 to the beam 18.

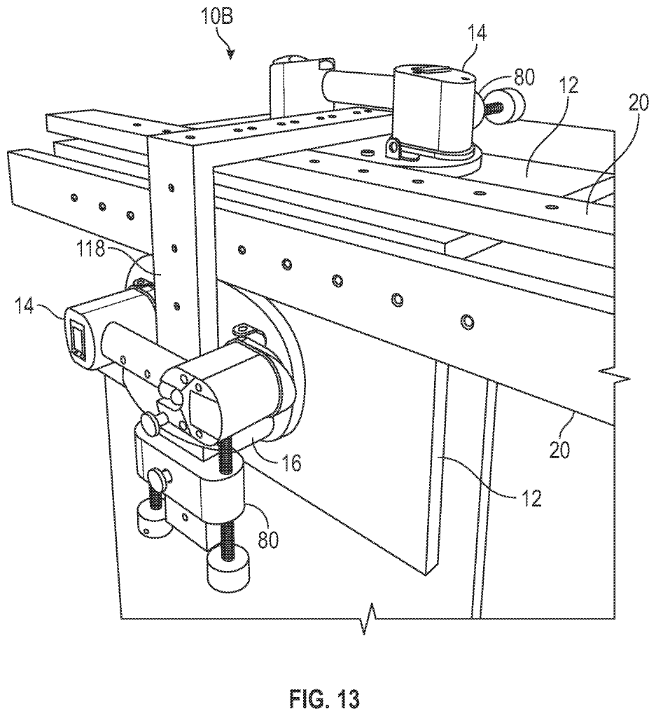

FIG. 13 shows the system in a miter configuration 10B. A horizontally-positioned slab 12 is to be joined to a vertically-positioned slab 12 as shown. A vacuum gripper 14 is secured to each, with a securing accessory 16 slidably receiving a leg of an L-shaped beam 118 and securing the leg to one of the vacuum grippers 14. An traction device 80 is secured to each leg of the L-shaped beam 118 outward of the vacuum gripper 14. The traction device 80 on each slab 12 can adjust the position of the slab 12 relative to the other slab 12. Height-adjusting devices 100 (not shown in FIG. 13, but similar to those shown in FIG. 8) can also be mounted to each leg of the L-shaped beam 118 to assist in aligning the two slabs 12 with one another.

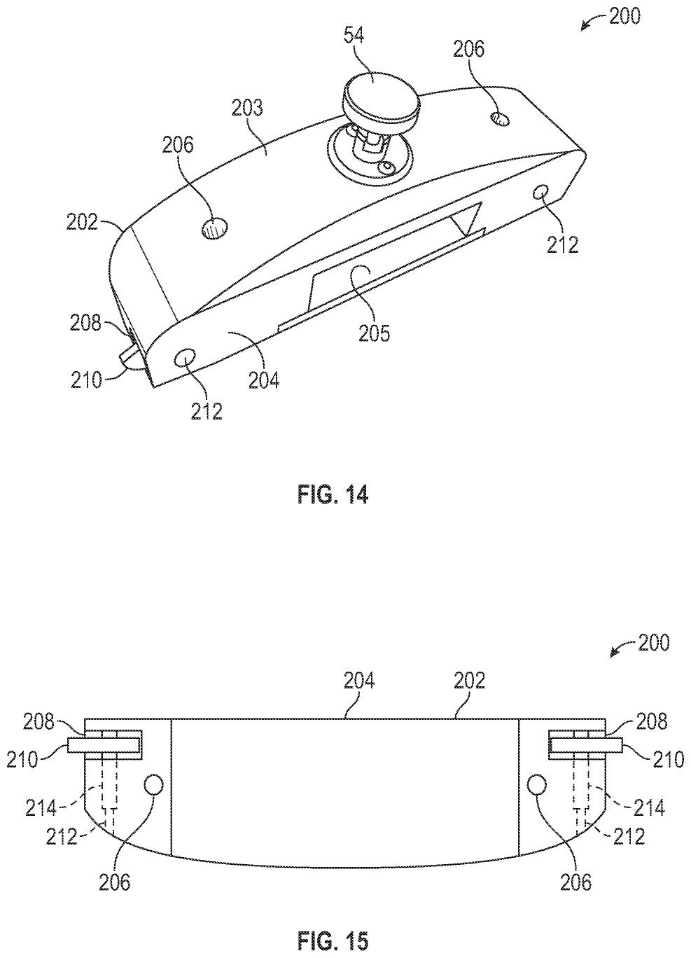

FIG. 14 shows a universal accessory 200 that can be used in the slab handling system configurations described herein. The universal accessory 200 includes an elongated body 202 having a convex upper surface 203. The elongated body 202 in this example is approximately 8″ in its longest dimension along the longitudinal axis. The elongated body 202 has opposed side surfaces 204, which in this example are approximately 2″ apart in the center. A large passageway 205 extends through the elongated body 202 in a direction perpendicular to the long axis of the elongated body 202 and perpendicular to the side surfaces 204. The large passageway 205 is generally rectangular and extends from an interior side to an exterior side of the elongated body 202. In this example, the large passageway 205 is approximately 1″ tall and approximately 3″ wide.

A pair of apertures 206 extend vertically completely through the elongated body 202 on either side of the large passageway 205. The apertures 206 extend through the upper surface 203.

Slots 208 are formed at bottom corners of the elongated body 202 at longitudinal ends of the elongated body 202. Connecting plates 210 are received in the slots 208. Apertures 212 extend through the elongated body 202 on either side of the large passageway 205 in a direction parallel to the large passageway 205. The apertures 212 intersect the slots 208.

FIG. 15 is a bottom view of the universal accessory 200. Referring to FIG. 15, threaded fasteners 214 are received in the apertures 212 and in corresponding apertures in the connecting plates 210 to retain the connecting plates 210 in the slots 208.

A spring-pin assembly 54, as described above, is again mounted to the upper surface 203 of the elongated body 202 and is reconfigurable so that a pin 74 (FIG. 7) protrudes into the large passageway 205 or is substantially retracted therefrom, as before.

The universal accessory 200 is reconfigurable as a securing assembly (as described above), a traction device (as described above), or as a height-adjusting device (as described above). In the configuration shown in FIGS. 14 and 15, the universal accessory 200 is configured as a securing assembly.

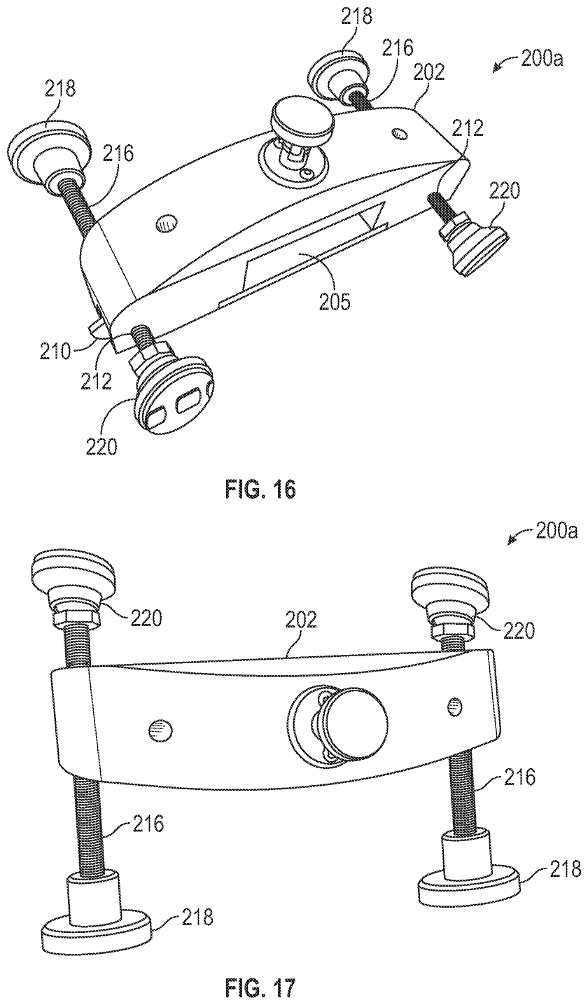

In FIGS. 16 and 17, the universal accessory 200 is configured as a traction device 200a. A threaded rod 216 is threaded through each aperture 212. A handle 218 is secured to one end of each threaded rod 216. A pivotable foot 220 is secured to the opposite end of each threaded rod 216. The threaded rods 216 may be threaded through the connecting plates 210.

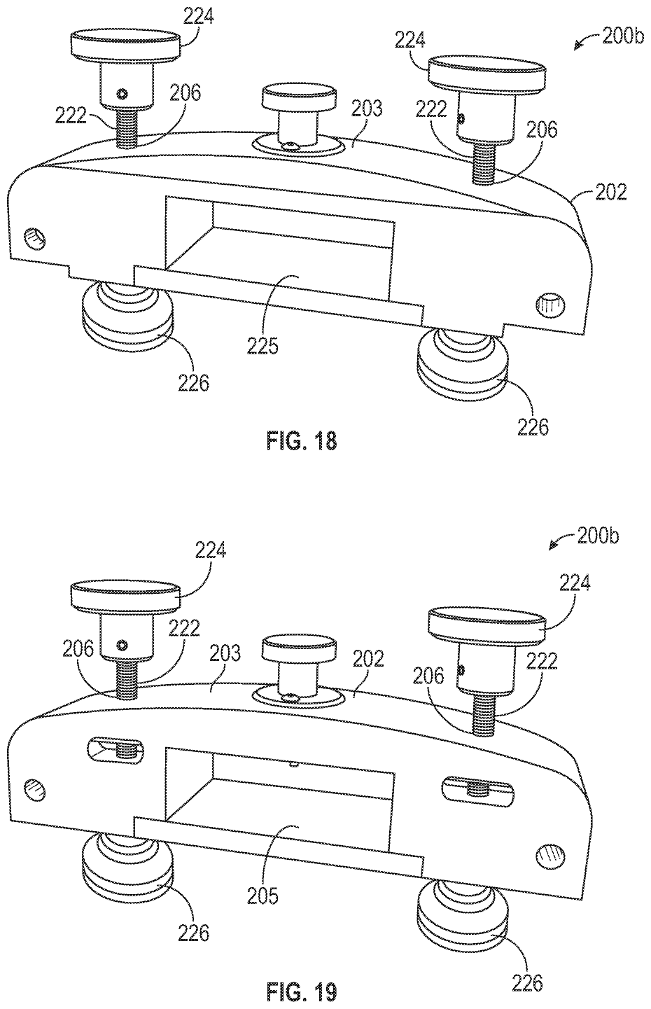

In FIGS. 18 and 19, the universal accessory 200 is configured as a height-adjusting device 200b. In this configuration, threaded rods 222 are threaded through the apertures 206 extending vertically through the elongated body 202. Each threaded rod 222 has a handle 224 on one end and a pivotable foot 226 at an opposite end. The threaded rods 216, handles 218, and feet 220 of FIGS. 16-17 could be used, or dedicated components could be used.

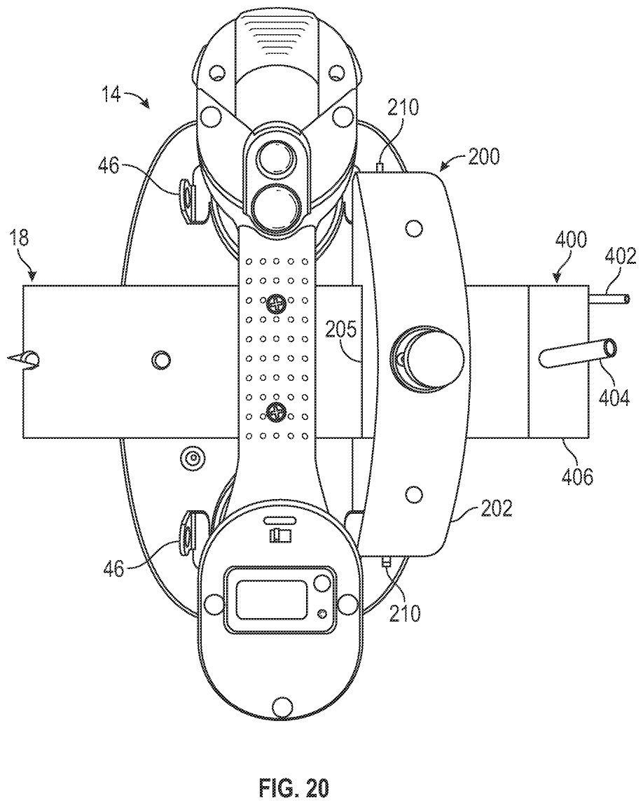

Referring to FIG. 20, the universal accessory 200 is in its securing assembly configuration, secured to the vacuum gripper 14 as before, i.e. the connectors 46 of the vacuum gripper 14 are received in the slots 208 (FIG. 15). FIG. 20 also shows an optional handle attachment 400 secured to one end of the beam 18, such as via a snap-fit connection. The handle attachment 400 includes a body 406 received within the beam 18. A first handle 402 is secured to and extends from the body 406 in a direction generally parallel to and away from the beam 18. A second handle 404 extend perpendicularly from the body 406. The handles 402, 404 facilitate lifting and handling a slab to which the vacuum gripper 14 is secured.

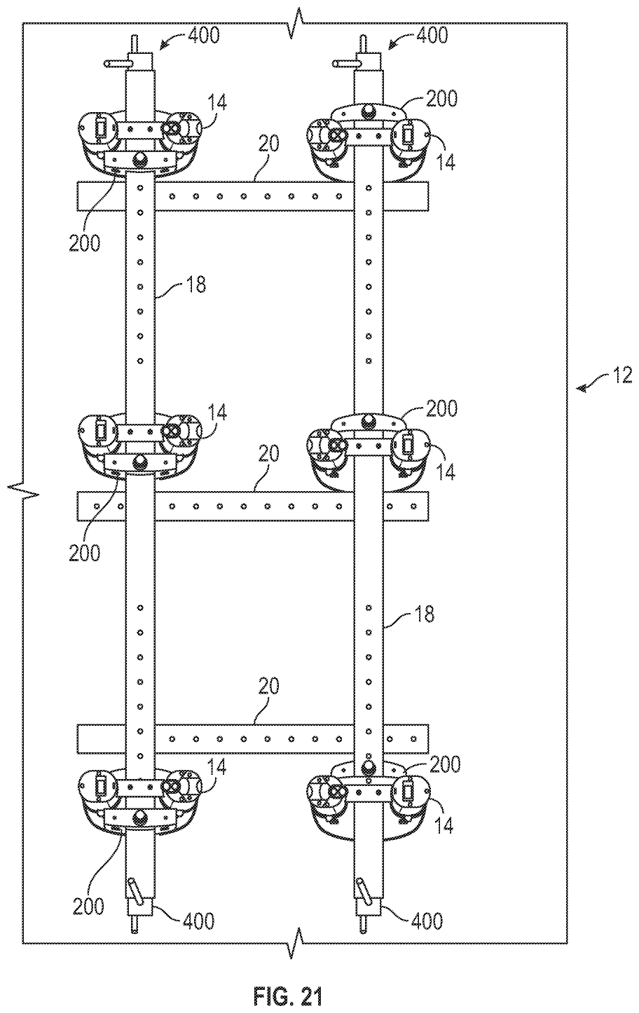

FIG. 21 shows a plurality of vacuum grippers 14 secured to a pair of beams 18 by securing assemblies 200. A plurality of shorter, similar beams 20 may be pinned between the beams 18 and the slab 12. The vacuum grippers 14 are secured to the slab 12. The slab 12 can then be carried and moved into place by people holding onto the beams 18 and the vacuum grippers 14. As before, the beams 18 could be lifted by a crane or the like. The handle attachment 400 of FIG. 20 could be used in the slab handling system of FIG. 21, as shown.

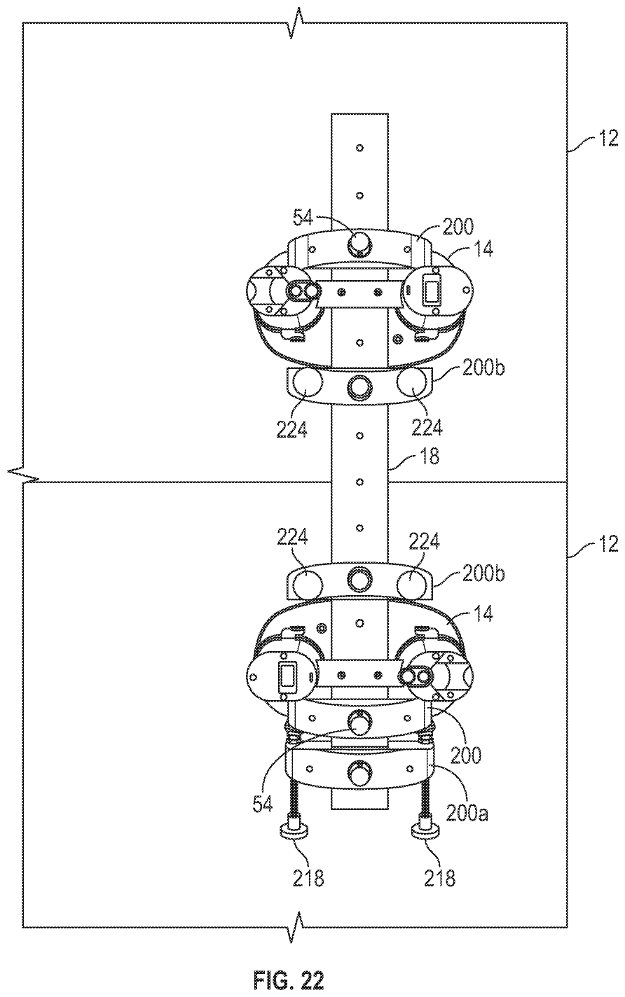

FIG. 22 shows the slab handling system in a seam setter configuration using two of the vacuum grippers 14 each having securing assembly 200 secured thereto (via the connectors 46 and slots 208 and fasteners 214 (FIG. 15 and FIG. 20). A beam 18 extends through the large passageways 205 (FIG. 14) of the securing assemblies 200. In this arrangement, only one traction device 200a is utilized, again positioned outward of that securing assembly 200, which is therefore not secured to the beam 18 via the spring-pin assembly 54. The other universal accessory 200 is secured to the beam 18 via its spring-pin assembly 54. The beam 18 extends through the large passageway 205 (not visible) of the traction device 200a.

In use, the handles 218 of the traction device 200a are turned to push the securing assembly 200 away from the traction device 200a. This has the effect of pulling the two slabs 12 toward one another. As explained previously, two traction devices 200a could also be used.

Additionally, the height-adjusting devices 200b may be secured to the beam 18 between the vacuum grippers 14, one over each slab 12. By turning the handles 224 of the two height-adjusting devices 200b, the relative heights of the adjacent slabs 12 can be precisely controlled to make them flush and even. The seam-setting configuration can be used to place the slabs 12 precisely and properly relative to one another. The system may be left in place until the slabs 12 are permanently (or sufficiently) set. The vacuum grippers 14 can then be released and the system can be removed.

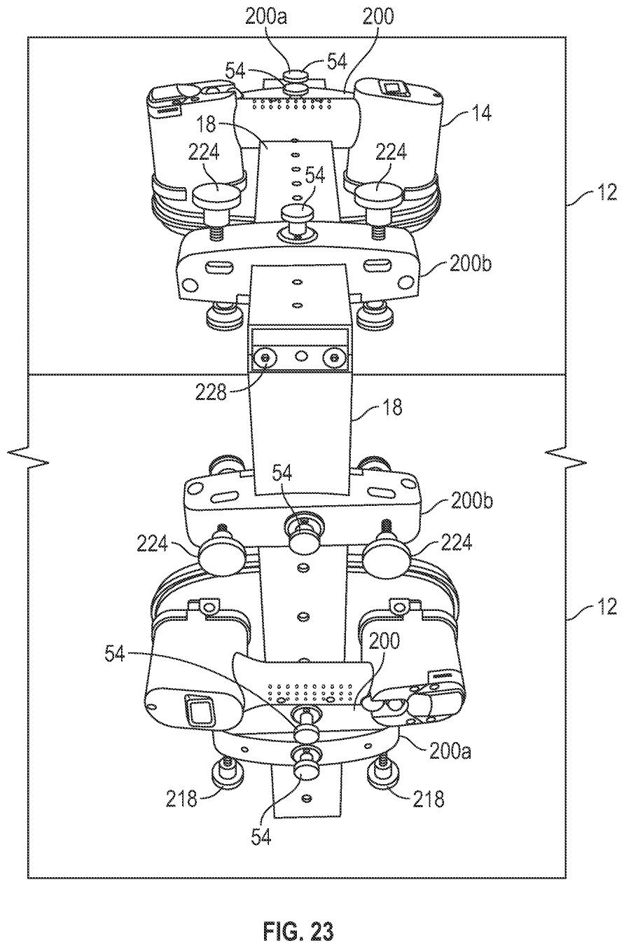

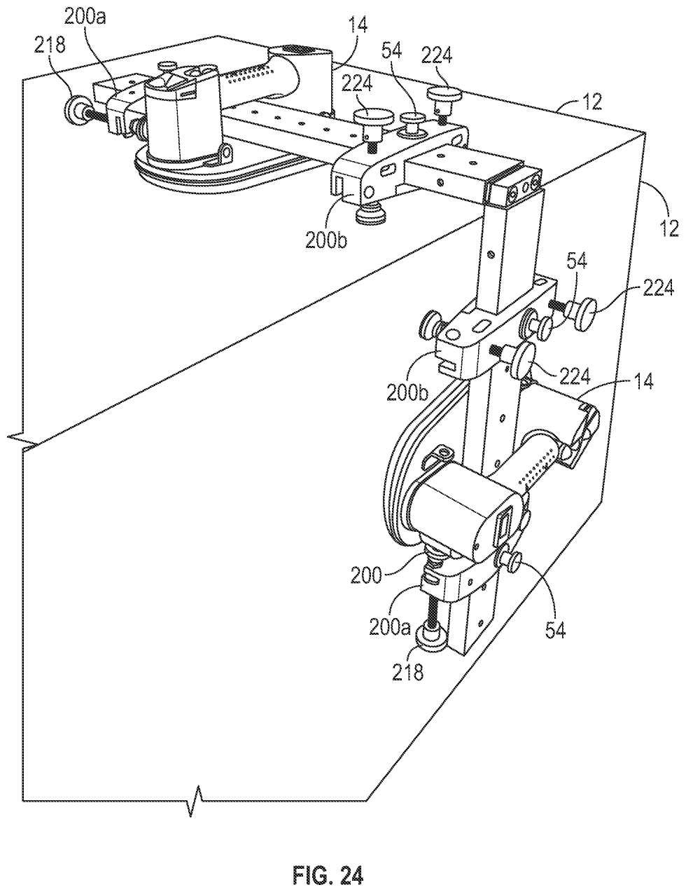

FIGS. 23 and 24 show the slab handling system in a miter configuration. A horizontally-positioned slab 12 is to be joined to a vertically-positioned slab 12 as shown. A vacuum gripper 14 is secured to each. A pair of securing assemblies 200 each slidably receive a beam 18 (i.e. the spring-pin assembly 54 is not engaged to the beam 18) and secures the beam 18 to one of the vacuum grippers 14. An L connector 228 connects the two beams 18 to one another in a perpendicular arrangement.

A traction device 200a is secured to each beam 18 outward of the vacuum gripper 14 (and its spring-pin assembly 54 is engaged with the beam 18). The traction device 200a on each slab 12 can adjust the position of the slab 12 relative to the other slab 12. By turning the handles 218 on the traction device 200a on the vertical slab 12, the position of the vertical slab 12 is adjusted vertically. By turning the handles 218 on the traction device 200a on the horizontal slab 12, the position of the horizontal slab 12 is adjusted horizontally.

Height-adjusting devices 200b assist in aligning the two slabs 12 with one another. Turning the handles 224 on the height-adjusting devices 200b on the vertical slab 12 will tilt the vertical slab 12 relative to the vertical plane. Turning the handles 224 on the height-adjusting devices 200b on the horizontal slab 12 will tilt the horizontal slab 12 relative to the horizontal plane.

Again, the system may be left in place until the slabs 12 are permanently (or sufficiently) set. The vacuum grippers 14 can then be released and the system can be removed.

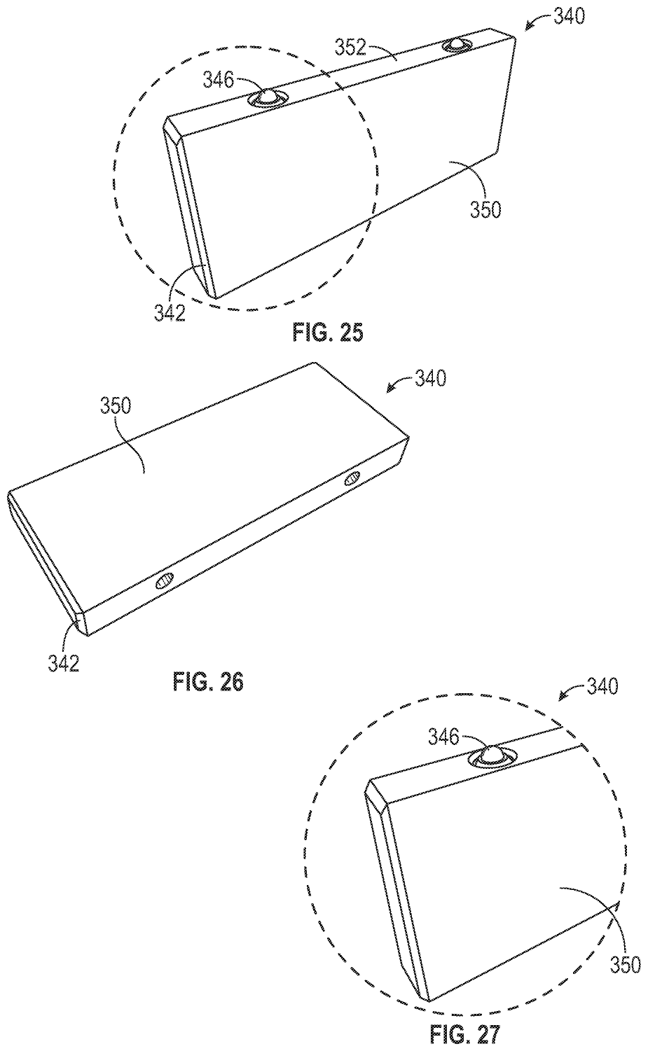

FIGS. 25-27 illustrate a beam connector 340. The beam connector 340 can be used to extend the length of a beam 18. More specifically, the beam connector 340 can be used to join two beam 18 into a single, straight, long beam. For example, beams 18 of FIG. 24 can be disconnected from one another and reconnected with the beam connector 340 to form a single, straight, long beam 18.

The beam connector 340 includes a body 350 and two metal spring-biased spherical closures 346 on each long edge of the body 350. The closures 346 are aligned and connected to the apertures of a beam 18. The beveled edge 342 portion on one side 352 of the connector 340 makes for an easy insertion and removal from the beam 18. FIGS. 26 and 27 shows the body 350 of the connector 340 in detail. The beam connector 340 is inserted directly into the parallel opening of the beam 18. The closures 346 are depressed inward during insertion and then snap outward into apertures in the beam segments to secure the beam segments to the beam connector 340.

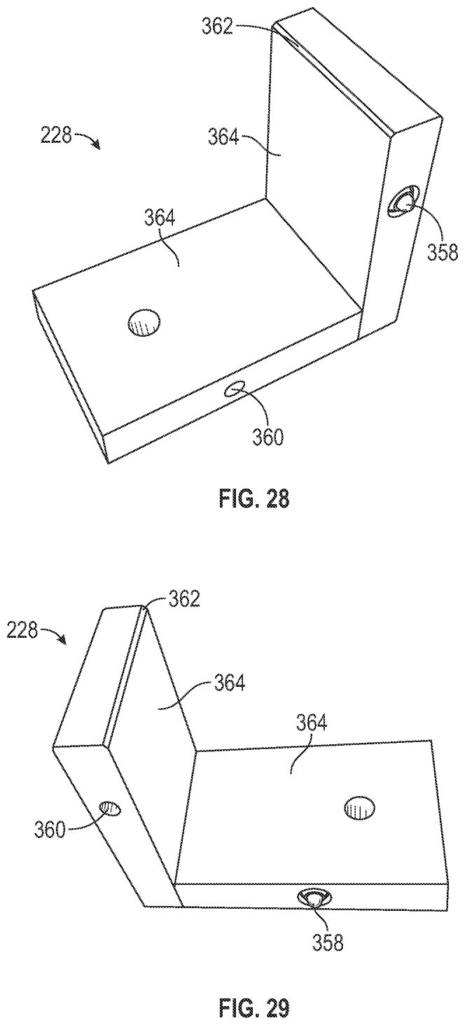

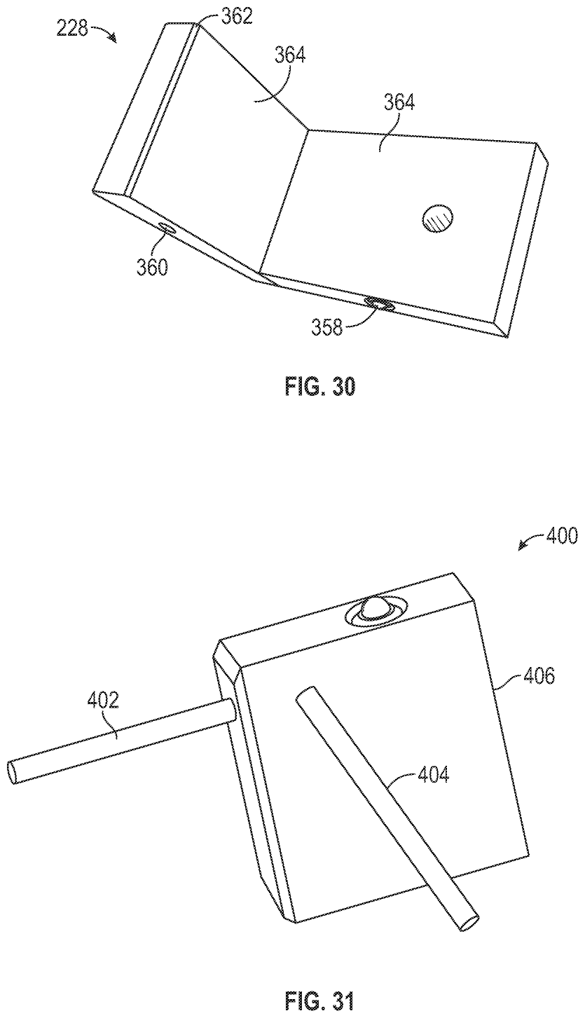

FIGS. 28-30 illustrates an L connector 228. The L connector 228 can be used to connect two beam segments to create L-shaped beams shown in FIG. 23-24. Similarly, above, the L connector 228 includes a body 364 and four metal spring-biased spherical closures 358 that are aligned and snap-fit connected to the apertures of a beam segments. The beveled edge 362 portion of the L connector 228 makes for an easy insertion and removal from the beam segments. The body 364 is inserted directly into the parallel opening of the beam 18.

FIG. 31 is an enlarged view of the handle attachment 400 of FIG. 20. Again, the first handle 402 is secured to and extends from the body 406 in a direction generally parallel to the body 406. The second handle 404 extend perpendicularly from the body 406. The handles 402, 404 facilitate lifting and handling a slab.

In accordance with the provisions of the patent statutes and jurisprudence, exemplary configurations described above are considered to represent preferred embodiments of the inventions. However, it should be noted that the inventions can be practiced otherwise than as specifically illustrated and described without departing from its spirit or scope. Alphanumeric identifiers on method steps are solely for ease in reference in dependent claims and such identifiers by themselves do not signify a required sequence of performance, unless otherwise explicitly specified.

What is claimed is:

1. An accessory for handling a slab comprising:
a body having a passageway therethrough for receiving a beam, the body further including slots on either side of the passageway, the slots configured to receive connectors of a vacuum gripper; and
a pin movable toward and away from the passageway for securing the body to a beam received in the passageway.

2. The accessory of claim 1 further including a lateral aperture on each side of the passageway, wherein the lateral apertures extend in a direction parallel to the passageway and intercept the slots.

3. The accessory of claim 2 further including a connecting plate received in each slot and retained in the slots by threaded fasteners received in the lateral apertures.

4. The accessory of claim 2 further including a vertical aperture on each side of the passageway, wherein the vertical apertures extend completely through an upper surface and lower surface of the body in a direction perpendicular to the passageway.

5. The accessory of claim 4 further including a threaded rod threadably received in each vertical aperture and extending completely through the body, a handle formed on an upper end of each threaded rod and a foot formed on a lower end of each threaded rod.

6. The accessory of claim 4 further including a threaded rod threadably received in each lateral aperture and extending completely through the body, a handle formed on one end of each threaded rod and a foot formed on an opposite end of each threaded rod.

7. The accessory of claim 1 wherein the pin is movably mounted to an upper surface of the body and is spring-biased downward to an engaged position, and wherein a handle at an upper end of the pin is rotatable to lock the pin in an upward, disengaged position and to release the pin to be spring-biased downward to the engaged position.

8. A slab-handling system including the accessory of claim 1 and further including a beam received in the passageway, wherein the beam includes an aperture into which the pin is received, thereby securing the beam in the passageway, the slab-handling system further including a vacuum gripper having connectors received in the slots of the body and secured in the slots of the body.

9. The slab-handling system of claim 8 wherein the accessory is a first accessory and the vacuum gripper is a first vacuum gripper, the system further including a second accessory secured to a second vacuum gripper, wherein the beam is received in the passageway of the second accessory.

10. The slab-handling system of claim 9 in combination with a slab, wherein the first vacuum gripper and the second vacuum gripper are secured to the slab via a vacuum force.

11. The slab-handling system of claim 9 in combination with a first slab and a second slab, wherein the first vacuum gripper is secured to the first slab via vacuum force and the second vacuum gripper is secured to the second slab via vacuum force.

12. The combination of claim 11 wherein the first slab and the second slab are generally parallel to one another.

13. The combination of claim 11 wherein the first slab and the second slab are generally perpendicular to one another.

14. The slab-handling system of claim 8 wherein the accessory is a first accessory, the system further including a second accessory, wherein the beam is received in the passageway of the second accessory.

15. The slab-handling system of claim 14 wherein the second accessory further includes a vertical aperture on each side of the passageway, wherein the vertical apertures extend completely through an upper surface and lower surface of the body in a direction perpendicular to the passageway, a threaded rod threadably received in each vertical aperture and extending completely through the body of the second accessory, a handle formed on an upper end of each threaded rod and a foot formed on a lower end of each threaded rod.

16. The slab-handling system of claim 15 wherein the body of the first accessory and the body of the second accessory are identical.

17. A slab-handling system including the accessory of claim 1 and further including a vacuum gripper having connectors received in the slots of the body and secured in the slots of the body.

18. A slab handling system comprising:
a plurality of vacuum grippers; and
a beam securing the plurality of vacuum grippers to one another.

19. The slab handling system of claim 18 wherein the beam is straight.

20. The slab handling system of claim 18 wherein the beam is L-shaped.

21. An accessory for handling a slab comprising:
a body having a passageway therethrough for receiving a beam, the body further including slots on either side of the passageway, the slots configured to receive connectors of a vacuum gripper;
a lateral aperture on each side of the passageway, wherein the lateral apertures extend in a direction parallel to the passageway; and
a vertical aperture on each side of the passageway, wherein the vertical apertures extend completely through an upper surface and lower surface of the body in a direction perpendicular to the passageway.
